(19) United States
(12) Patent Application Publication
(10) Pub. No.: US 2008/0122277 A1
(43) Pub. Date: May 29, 2008

(54) Vehicle Seat Height Adjuster

(75) Inventors: Cornel Labuwy, Remscheid (DE); Jorg Seibt, Koln (DE); Bernd Gross, Langenfeld (DE)

Correspondence Address: FOLEY AND LARDNER LLP;SUITE 500, 3000 K STREET NW, WASHINGTON, DC, 20007, US

(73) Assignee: Johnson Controls GmbH

(21) Appl. No.: 11/667,860

(22) PCT Filed: Nov. 14, 2005
(86) PCT No.: PCT/EP2005/055956

§ 371 Date: Nov. 9, 2007

(30) Foreign Application Priority Data
Nov. 17, 2004 (DE) 10 2004 055 535.4

(51) Int. Cl. B60N 2/16; B60N 2/18; B60N 2/68

(52) U.S. Cl. 297/311

(57) ABSTRACT

A structure element for a seat includes a plurality of positioning modules at which an adjusting device may be optionally provided for adjusting a height of the seat. The structure element is configured such that the adjusting device can be selectively arranged on any one of the plurality of positioning modules.

### CROSS-REFERENCE TO RELATED PATENT APPLICATIONS

The present application is a National Stage of International Application No. PCT/EP2005/055956 filed on Nov. 14, 2005, which claims the benefit of German Patent Application No. DE 10 2004 055 535.4 filed on Nov. 17, 2004. The entire disclosures of International Application No. PCT/EP2005/055956 and German Patent Application No. DE 10 2004 055 535.4 are incorporated herein by reference.

### BACKGROUND

The present disclosure relates to a structure element for a seat. In particular, the present disclosure relates to a structure element for a motor vehicle seat and to a seat structure with the structure element, as well as a seat with the structure element or the seat structure.

In order to meet the requirements of customers in the vehicle industry, in particular in the motor vehicle industry, vehicle components and, in particular, interior components, are often adapted specifically to a model, and also within the same model series, to the demands of customers. At the same time, it is desirable to keep the number of components in the production of the vehicle as low as possible so that the storage costs are as low as possible and the batches of components are large, as thereby the storage and the components are inexpensive. Thus, there continues to be a need for a structure element that may be used in many different ways (e.g., in different vehicle models, for different requirements of the same vehicle or for different requirements of the same vehicle model) and that may be produced and assembled inexpensively.

### SUMMARY

One exemplary embodiment relates to a structure element for a seat. The structure element comprises a plurality of positioning modules at which an adjusting device may be optionally provided for adjusting a height of the seat. Each positioning module includes at least one fastening element for fastening an adjusting drive of the adjusting device.

Another exemplary embodiment relates to a seat structure for a vehicle. The seat structure comprises an adjusting device and at least one structure element. The at least one structure element is arranged substantially parallel to a seat direction and comprises a plurality of positioning modules at which the adjusting device may be provided. Each positioning module includes at least one fastening element.

Another exemplary embodiment relates to a seat for a vehicle. The seat comprises a seat structure comprising an adjusting device and at least one structure element. The at least one structure element is arranged substantially parallel to a seat direction and comprises a plurality of positioning modules at which the adjusting device may be provided. Each positioning module includes at least one fastening element being arranged substantially parallel to a seat direction, the at least one structure element comprising a plurality of positioning modules at which the adjusting device may be provided, each positioning module including at least one fastening element for supporting the adjusting device.

### BRIEF DESCRIPTION OF THE DRAWINGS

FIG. 1 is a perspective view of a structure element according to an exemplary embodiment.

FIG. 2A is a perspective view of a first side of a seat structure according to an exemplary embodiment with the structure element of FIG. 1 and two adjusting devices that are respectively arranged in one positioning module.

FIG. 2B is a perspective view of a second side of the seat structure of FIG. 2A.

FIG. 3A is a perspective view of a first side of a seat structure according to another exemplary embodiment with the structure element of FIG. 1 showing one of two adjusting devices arranged at a different positioning module than the adjusting device in the embodiment of FIG. 2A.

FIG. 3B is a perspective view of the second side of the seat structure of FIG. 3A.

FIG. 4A is a perspective view of a first side of a seat structure according to another exemplary embodiment with the structure element of FIG. 1 and having an adjusting device that may be adjusted using an actuating device.

FIG. 4B is a perspective view of the second side of the seat structure of FIG. 4A.

### DETAILED DESCRIPTION

According to an exemplary embodiment, a structure element for a motor vehicle seat is provided that may be used in many different ways (e.g., in different vehicle models, for different requirements of the same vehicle or for different requirements of the same vehicle model) and that may be produced and assembled inexpensively. The structure element generally comprises a plurality of positioning modules at which an adjusting means or device may be optionally provided (e.g., for the height adjustment of the seat). The adjusting device may be selectively arranged at any one of the plurality of positioning modules so that the same structure element may be used for different requirements in the same vehicle or in different model series without having to adapt the structure element. For such an embodiment, the structure element may be produced in very large batches and a plurality of different structure elements do not have to be stored for different requirements. As a result, the purchase and storage of the structure elements may be relatively inexpensive.

According to an exemplary embodiment, each positioning module comprises at least one fastening means or element for fastening an adjusting drive of the adjusting device so that the adjusting drive may be assembled easily and rapidly.

The structure element extends substantially two-dimensionally and has a first or front face and a second or rear face. Thus, the structure element may be produced from a material extending substantially two-dimensionally (e.g., a plate formed of steel). Persons skilled in the art will understand that the structure element may be provided with edges, beads and/or embossments for increasing the rigidity and/or the production of slots against which components are able to bear. The machining of metal plates may be carried out inexpensively by conventional or otherwise suitable means.

According to an exemplary embodiment, the positioning modules generally comprise one or more recesses (or at least a portion thereof) for passing through an adjusting output element of the adjusting device (e.g., from the front face to the rear face). According to an alternative embodiment, the positioning modules do not include any recesses for passing through an adjusting output element of the adjusting device. For example, for such an embodiment, the adjusting drive and the adjusting output element may both be provided on the front face or both on the rear face of the structure element.

According to an exemplary embodiment, the structure element comprises at least one first means or element and one second means or element for arranging rockers so that the structure element may be supported by the rockers on other structure elements and/or the bodywork.

According to an exemplary embodiment, the positioning modules have a positioning means or element (or at least a portion thereof) for arranging a fitting part and at least partially a locating means or element for arranging a limiting means or device. The arrangement of the positioning element and the locating element allows the structure element to be adapted in many different ways to different requirements.

According to an exemplary embodiment, the fastening element, the recess, the first and/or the second elements, the positioning element and/or the locating element are holes with the same or different diameter and/or with a different cross section. The holes may also be provided with threads. The insertion of holes into a material extending two-dimensionally is relatively inexpensive and is possible by means of conventional or other suitable methods.

According to an exemplary embodiment, the structure element comprises further elements (e.g., recesses, holes and/or slots) that, for example, may be used for arranging other structure elements or further functions.

According to an exemplary embodiment, the positioning modules have at least partially the same fastening element and/or locating element or a fastening means or element of a positioning module is a locating means or element of a further positioning module. As a result, the number of fastening elements and/or locating elements is reduced and the production cost is lower.

According to an exemplary embodiment, the structure element may be produced relatively inexpensively from a material extending substantially two-dimensionally (e.g., a metal plate) and is provided with a plurality of positioning modules and/or elements (e.g., holes) for arranging further parts and components. As a result, the structure elements may be used in different vehicle models and for different requirements of different vehicle models, different vehicles or the same vehicle. The structure element may be produced by conventional methods and may reduce the storage cost by its flexible applicability. Low storage cost and/or large batches may allow the production costs of the vehicle to be reduced.

According to another exemplary embodiment, a seat structure comprises at least one structure element with an adjusting means or device. The structure element is arranged substantially parallel to a seat direction. Due to the use of the structure element, the seat structure may be easily adapted to requirements which are specific to the seat and/or vehicle and may be used in very many different ways.

According to an exemplary embodiment, the seat structure comprises a plurality of rockers. Each rocker comprises a first end and a second end. The first ends are arranged so that the rockers are rotatably supported relative to the bodywork and/or further seat structure elements. The second ends are arranged so that the rockers are rotatable relative to another means or element. The rockers allow for an adjustment of the position of the structure element and/or the seat structure relative to the bodywork and/or further seat structure elements.

According to an exemplary embodiment, the adjusting device is arranged on one of the plurality of positioning modules. The adjusting device allows for an adjustment of the position of the structure element relative to the bodywork and/or further seat structure elements. According to an exemplary embodiment, the adjusting device is a height adjuster for raising and lowering the structure element and/or the seat structure. According to an exemplary embodiment, the adjusting device also adjusts the inclination of the seat.

According to an exemplary embodiment, the adjusting device comprises an adjusting drive that is arranged on the front face and/or the rear face of the structure element and is supported by fastening elements at the positioning module. According to an exemplary embodiment, the adjusting drive is a height adjustment pump. Persons skilled in the art will understand that other adjusting drives (e.g., an electric motor) may also be used.

According to an exemplary embodiment, the adjusting device comprises at least one adjusting output element, such as a shaft. According to an exemplary embodiment, the adjusting output element is guided through the recess of the positioning module. The adjusting output element comprises first positive and/or non-positive connecting means or elements that are in at least partial engagement with second positive and/or non-positive connecting means or elements of a fitting part. The fitting part is arranged in a rotatable manner at the positioning element. When rotating the adjusting output element, the second positive and/or non-positive connecting elements roll on the first positive and/or non-positive connecting elements so that the fitting part is rotated. According to an exemplary embodiment, the first and second positive and/or non-positive connecting elements are teeth that allow the adjustment to be carried out uniformly.

According to an exemplary embodiment, a limiting means or device arranged on the locating element of the positioning module, limits the rotation of the fitting part. The limiting device limits the adjustment of the position of the structure element and/or the seat structure relative to the bodywork. According to an exemplary embodiment, the limiting device is a cam or a pin that engages in a recess of the fitting part. According to an alternative embodiment, the limiting device is a slot into which a cam or a pin of the fitting part engages.

According to an exemplary embodiment, the fitting part is connected fixedly in terms of rotation to the second end of one of the rockers or is integral therewith. When rotating the output element, therefore, the fitting part is rotated, whereby the rockers are rotated, whereby the structure element and/or the seat structure is able to be raised or lowered. According to an exemplary embodiment, the rotationally fixed connection of the fitting part to one of the rockers is carried out by means of a coupling means or element.

According to an exemplary embodiment, the seat structure comprises an actuating means or device (e.g., a lever or a handle) by means of which the adjusting device may be adjusted. According to an exemplary embodiment, the actuating device is arranged to the front in the seat direction so that it is easily accessible for a user.

According to another exemplary embodiment, a seat for a vehicle (e.g., a motor vehicle) comprises a structure element and/or a seat structure of at type detailed above. As a result, the seat may be easily adapted to requirements specific to the seat and/or vehicle and/or the relative position of the seat (e.g., its height) to the bodywork may be easily altered. The seat may be made inexpensively.

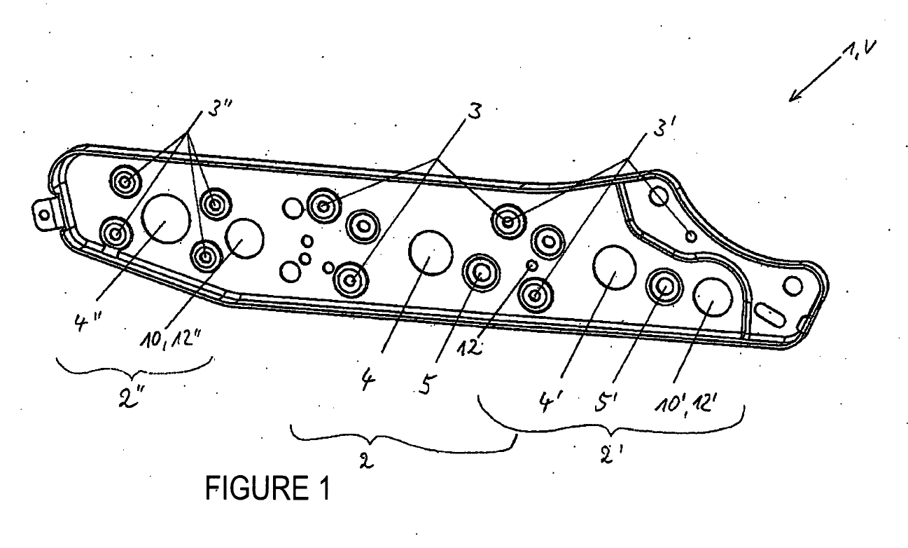

Referring specifically to the FIGURES, and in particular to FIG. 1, a structure element 1 is shown according to an exemplary embodiment. The structure element 1 comprises a first positioning module 2, a second positioning module 2′, as well as a third positioning module 2″. Each of the positioning modules 2, 2′, 2″ respectively comprise fastening means or elements 3, 3′, 3″ for fastening at least one adjusting drive 60, 60″ of at least one adjusting means or devices 6, 6″. Each of the positioning modules 2, 2′, 2″ further comprise a recess 4, 4′, 4″ for passing through at least one adjusting output element 600, 600″ of the at least one adjusting device 6, 6″.

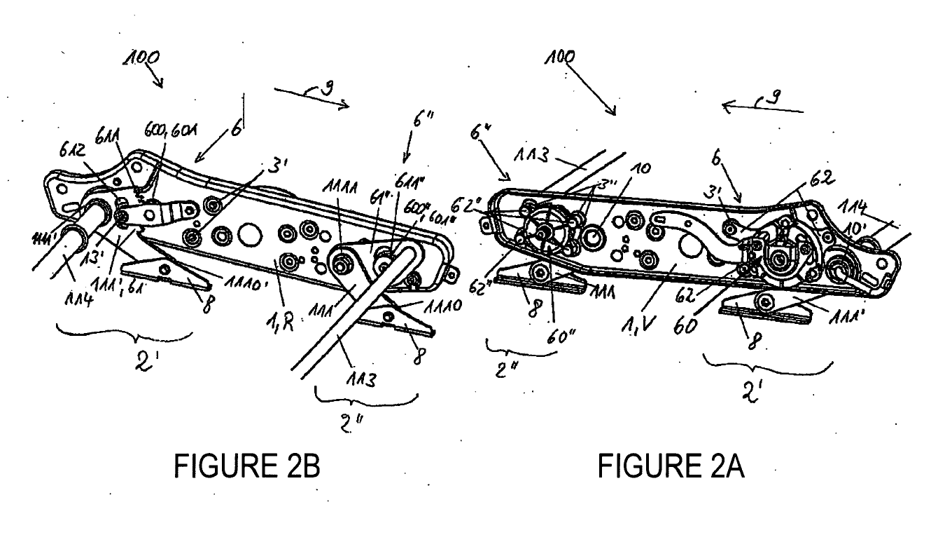

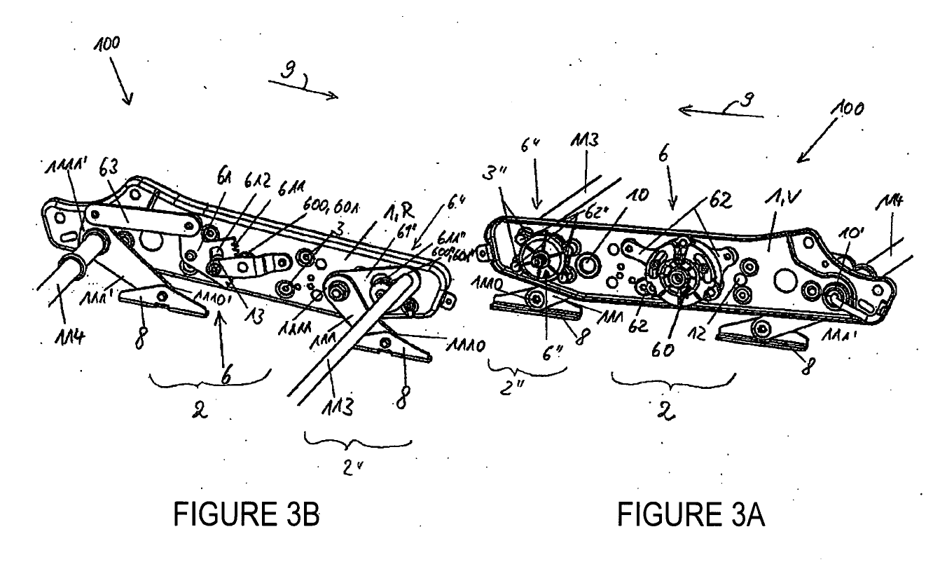

The structure element 1 extends substantially two-dimensionally and comprises a front face V (shown in FIG. 2A) and a rear face R (shown in FIG. 2B). The positioning modules 2, 2′, 2″ further comprise at least partially a positioning means or element 12, 12′, 12″ for arranging a fitting part 61, 61″ and at least partially a locating means or element 5, 5′ of the positioning modules 2, 2′. The fitting part 61, 61″ and the locating element 5, 5′ arrange a limiting means or device 13, 13′. The fitting part 61, 61″ and the limiting device 13, 13′ are shown in FIGS. 2A-3B. The structure element 1 further comprises a first and second means or elements 10, 10′ for arranging rockers 111, 111′ by means of which the position of the structure element 1 relative to the bodywork 8 is able to be adjusted (see FIGS. 2A-4B).

Referring to FIGS. 2A and 2B, a seat structure 100 is shown according to an exemplary embodiment with the structure element 1 of FIG. 1 and two adjusting means or devices 6, 6″. One of the two adjusting devices 6, 6″ is an adjusting device for adjusting the height of the seat and is arranged in the second positioning module 2′ and is denoted hereinafter as “height adjuster” 6. The other of the two adjusting devices 6, 6″ is an adjusting device for adjusting the inclination of the seat and arranged in the third positioning module 2″ and is denoted hereinafter as “inclination adjuster” 6″.

FIG. 2A shows the seat structure 100 in a view in which the front face V of the structure element 1 is visible, while FIG. 2B shows the seat structure 100 in a view in which the rear face R of the structure element 1 is visible. The structure element 1 is arranged substantially parallel to the seat direction 9. Both adjusting devices 6, 6″ comprise one adjusting drive 60, 60″ that is respectively arranged on the front face V using fastening elements 62, 62″ in combination with the fastening elements 3′, 3″ of the positioning modules 2′, 2″. A first rocker 111 is arranged with its first end 1110, 1110′ on the first element 10 of the structure element 1, while a second rocker 111′ is arranged with its second end 1111, 1111 ′ on the second element 10′ of the structure element 1. The first end 1110, 1110′ of the rockers 111, 111′ is respectively arranged rotatably on the bodywork 8.

The seat structure 100 further comprises a third rocker and/or a fourth rocker (not shown). The third rocker is arranged substantially parallel to the first rocker 111 and the fourth rocker is arranged substantially parallel to the second rocker 111′. The third and fourth rockers are connected to the second ends 1111, 1111′ of the first rocker 111 and the second rocker 111′ respectively by means of connecting means or devices 113, 114 that are arranged substantially transversely to the seat direction 9. The first and second rockers 111, 111′ are, with their second end 1111, 1111′, respectively connected to one of the connecting devices 113, 114. According to an exemplary embodiment, the connecting device 114 of the height adjuster 6 is welded or connected fixedly in terms of rotation to the second rocker 111′ and arranged rotatably on the structure element 1, while the connecting device 113 of the inclination adjuster 6″ is arranged fixedly in terms of rotation on the fitting part 61″ of the inclination adjuster 6″ (the fitting part 61″ being rotatably arranged on the first element 10 for arranging the first rocker 111) so that the first and second rockers 111, 111′ with their second end 1111, 1111′ are respectively rotatably arranged on the structure element 1.

The adjusting devices 6, 6″ respectively comprise an adjusting output element 600, 600″, shown as a shaft, that is respectively guided through the recess 4′, 4″ of the positioning modules 2′, 2″. Hereinafter, therefore, the term “shaft” 600, 600″ is used instead of the term “adjusting output element”. The shaft 600, 600″ of each of the two adjusting devices 6, 6″ respectively comprises first positive and/or non-positive connecting means or elements 601, 601″ that are respectively in engagement with second positive and/or non-positive connecting means or elements 611, 611″ respectively of a fitting part 61, 61″. According to an exemplary embodiment, the fitting part 61 of the height adjuster 6 is integral with the second rocker 111′ and both fitting parts 61, 61″ are arranged on the rear face R. The positioning element 12′ of the structure element 1 for arranging the fitting part 61 of the height adjuster 6 is, therefore, the second element 10′ for arranging the second rocker 111′, while the positioning element 12″ for arranging the fitting part 61″ of the inclination adjuster 6″ is the first element 10 for arranging the first rocker 111. The fitting part 61 of the height adjuster comprises a recess 612 in which a limiting means or device 13′, shown as a pin, is arranged on the locating means 5′ of the structure element 1 for limiting the rotation of the fitting part 61.

In this embodiment, the second rocker 111′ is directly driven by means of the shaft 600 so that the force of the adjusting drive 60 of the height adjuster 6 is directly transmitted to the second rocker 111′ and therefore the flux of force is improved.

According to the various alternative embodiments, it is also possible that no inclination adjuster 6″ is provided on the seat structure in addition to the height adjuster 6.

Referring to FIGS. 3A and 3B, the seat structure 100 of FIGS. 2A and 2B is shown with the height adjuster 6 arranged in a first positioning module 2 in contrast to the embodiment shown in FIGS. 2A and 2B. FIG. 3A shows the seat structure 100 with the front face V of the structure element 1, while FIG. 3B shows the seat structure 100 with the rear face R of the structure element 1. In this embodiment, the second rocker 111′ is also adjusted by means of the height adjuster 6, however, the fitting part 6 is not integral with the second rocker 111′ but rather is arranged on a locating means or element 5 of the first positioning module 2 and is connected fixedly in terms of rotation by means of a coupling rod 63 to the second end 1111′ of the second rocker 111′.

The force of the adjusting drive 60 of the height adjuster 6 is transmitted indirectly to the second rocker 111′ and namely via the coupling rod 63, so that the coupling rod 63 is in the flux of force and absorbs forces in the event of a crash.

An embodiment is also possible in this position of the height adjuster, in which no inclination adjuster is provided in addition to the height adjuster.

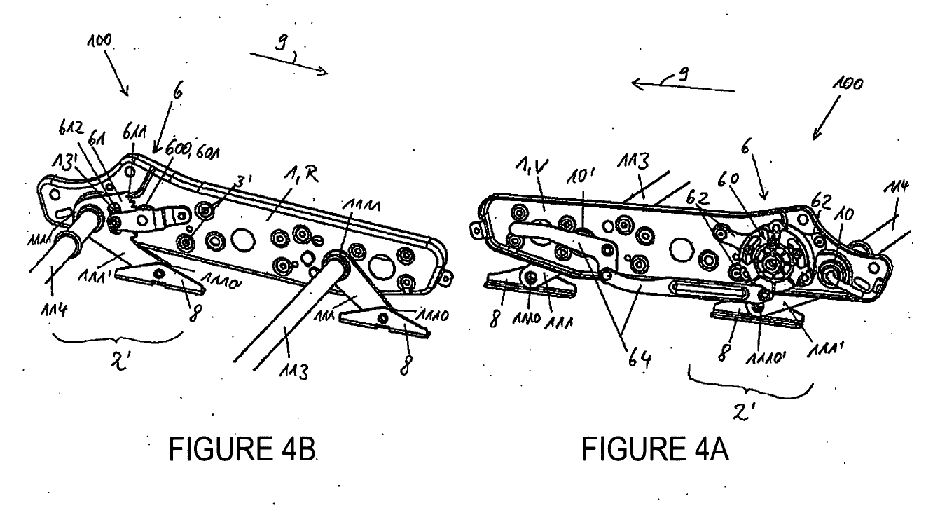

Referring to FIGS. 4A and 4B, a seat structure 100 is shown according to another exemplary embodiment. The seat structure 100 comprises an adjusting means or device 6 that may be adjusted by means of an actuating means or device 64. FIG. 4A shows the seat structure 100 with the front face V of the structure element 1, while FIG. 4B shows the seat structure 100 with the rear face R of the structure element 1. The adjusting device 6 is a height adjuster 6 and arranged on the second positioning module 2′ (similar to the embodiment of FIGS. 2A and 2B) and directly drives the second rocker 111′, which is integral with the fitting part 61. According to the embodiment illustrated, the actuating device 64 comprises a lever and a coupling rod. The coupling rod is arranged on the adjusting drive 60. Therefore, the actuation by means of the actuating device 64 is displaced to the front in the seat direction 9, and the adjusting device 6 may, therefore, be operated more easily for the user.

The force transmission from the adjusting drive 60 to the rocker 111′ is carried out directly as in the embodiment illustrated in FIGS. 2A and 2B. The coupling rod of the actuating means 64 is not located in the flux of force and, therefore, also does not absorb any forces in the event of a crash.

According to the embodiment illustrated in FIGS. 4A and 4B, the seat structure 100 does not have an inclination adjuster 6″. The first rocker 111 is arranged with its first end 1111 rotatably on the structure element 1 and is arranged fixedly in terms of rotation on the connecting device 113 (e.g., by being welded). The connecting device 113 is arranged rotatably on the structure element 1.

1. A structure element for a seat comprising:
a plurality of positioning modules at which an adjusting device may be optionally provided for adjusting a height of the seat.

2. The structure element of claim 1 wherein each positioning module comprises at least one fastening element for fastening an adjusting drive of the adjusting device.

3. The structure element of claim 1 wherein the structure element is substantially a two-dimensional member having a first face and a second face.

4. The structure element of claim 3 wherein the plurality of positioning modules each include at least one recess for passing through an adjusting output element of the adjusting device from the first face to the second face.

5. The structure element of claim 1 further comprising at least one first element and one second element for arranging rockers.

6. The structure element of claim 1 wherein the plurality of positioning modules each have at least one positioning element for arranging a fitting part.

7. The structure element of claim 2 wherein the plurality of positioning modules each comprise at least one locating element for arranging a limiting device.

8. The structure element of claim 7 wherein the plurality of positioning modules each have the same fastening element and locating element.

9. A seat structure comprising:
an adjusting device; and
at least one structure element being arranged substantially parallel to a seat direction, the at least one structure element comprising a plurality of positioning modules at which the adjusting device may be provided, each positioning module including at least one fastening element.

10. The seat structure of claim 9 wherein the adjusting device is selectively arranged on one of the plurality of positioning modules.

11. The seat structure of claim 9 further comprising an actuating device for adjusting the adjusting device.

12. The seat structure of claim 9 wherein the adjusting device comprises an adjusting drive that is arranged on at least one of a first face and a second face of the structure element, the adjusting device being supported by fastening member at a fastening element of the positioning module.

13. The seat structure of claim 9 wherein the adjusting device comprises at least one adjusting output element in the form of a shaft.

14. The seat structure of claim 13 wherein the adjusting output element comprises a first connecting element that is in engagement with a second connecting element of a fitting part, the fitting part being rotatable on a positioning element at the plurality of positioning modules.

15. The seat structure of claim 14 further comprising a limiting device arranged on a locating element at the plurality of positioning module that limits the rotation of the fitting part.

16. The seat structure of claim 15 further comprising a plurality of rockers, each rocker comprising a first end and a second end, the first end being arranged rotatably on a bodywork, the second end being arranged rotatably on one of a first element and a second element of the structure element.

17. The seat structure of claim 16 wherein the fitting part is fixed in terms of rotation to the second end of one of the rockers so that by rotating the adjusting output element, the second connecting element rolls on the first connecting element to move the fitting part and the rockers between a raised and a lowered position.

18. A seat for a vehicle comprising:
a seat structure comprising:
an adjusting device; and
at least one structure element being arranged substantially parallel to a seat direction, the at least one structure element comprising a plurality of positioning modules at which the adjusting device may be provided, each positioning module including at least one fastening element for supporting the adjusting device.

19. The seat of claim 18 wherein the adjusting device is selectively arranged on any one of the plurality of positioning modules.

20. The seat of claim 19 further comprising an actuating device for adjusting the adjusting device comprises an adjusting drive that is arranged on at least one of a first face and a second face of the structure element, the adjusting device being supported by a fastening member at a fastening element of the positioning module.
